(19) United States
(12) Patent Application Publication
(10) Pub. No.: US 2024/0031615 A1
(43) Pub. Date: Jan. 25, 2024

(54) MEDIA FILE PLAY METHOD AND APPARATUS, ELECTRONIC DEVICE, SERVER, AND MEDIUM

(71) Applicant: VIVO MOBILE COMMUNICATION CO., LTD., Dongguan (CN)

(72) Inventor: Shanguo LIU, Dongguan (CN)

(73) Assignee: VIVO MOBILE COMMUNICATION CO., LTD., Dongguan (CN)

(21) Appl. No.: 18/372,686

(22) Filed: Sep. 25, 2023

Related U.S. Application Data
(63) Continuation of application No. PCT/CN2022/082076, filed on Mar. 21, 2022.

(30) Foreign Application Priority Data
Mar. 26, 2021 (CN) 202110328077.1

(51) Int. Cl. H04N 21/2183; H04N 21/845

(52) U.S. Cl. CPC H04N 21/2183; H04N 21/8456

(57) ABSTRACT

A media file play method, an electrical device, and a medium are provided. The media file play method includes: sending a first request message to a server, where the first request message is used to request to play a target media file, the target media file includes a first segment and a second segment; receiving a target configuration file sent by the server, where the target configuration file includes at least first index information and second index information, the first index information is used to indicate the first segment, and the second index information is used to indicate the second segment; caching and playing the first segment, and associating the first index information with the cached first segment; and retrieving cache content based on the second index information, and playing the cached first segment when the second index information is the same as the first index information.

### CROSS-REFERENCE TO RELATED APPLICATIONS

This application is a continuation of International Application No. PCT/CN2022/082076, filed Mar. 21, 2022, which claims priority to Chinese Patent Application No. 202110328077.1, filed Mar. 26, 2021. The entire contents of each of the above-referenced applications are expressly incorporated herein by reference.

### TECHNICAL FIELD

This application relates to the field of communication technologies, and specifically relates to a media file play method and apparatus, an electronic device, a server, and a medium.

### BACKGROUND

With development of communication technologies, electronic devices are increasingly widely used.

Currently, a user may play a media file by using an electronic device. Specifically, the user may tap a multimedia application icon to trigger the electronic device to display a multimedia application play interface, and the user performs an operation on the play interface to trigger the electronic device to download a media file from a server and play the media file.

However, in some cases, because there may be duplicate segments in the foregoing media file (for example, duplicate actions in a moving video), if the foregoing manner is used, the electronic device may download the duplicate segments from the server again, resulting in a waste of traffic.

### SUMMARY

Embodiments of this application aim to provide a media file play method and apparatus, an electronic device, a server, and a medium.

According to a first aspect, an embodiment of this application provides a media file play method, and the method includes:
sending a first request message to a server, where the first request message is used to request to play a target media file, the target media file includes a first segment and a second segment, and a play sequence of the first segment is earlier than a play sequence of the second segment;
receiving a target configuration file sent by the server, where the target configuration file includes at least first index information and second index information, the first index information is used to indicate the first segment, and the second index information is used to indicate the second segment;
after the first segment is obtained from the server based on the first index information, caching and playing the first segment, and associating the first index information with the cached first segment; and
retrieving cache content based on the second index information, and playing the cached first segment in a case that the second index information is the same as the first index information.

According to a second aspect, an embodiment of this application further provides a media file play method, and the method includes:
receiving a first request message sent by an electronic device, where the first request message is used to request to play a target media file, the target media file includes a first segment and a second segment, and a play sequence of the first segment is earlier than a play sequence of the second segment; and
sending a target configuration file to the electronic device based on the first request message, where the target configuration file includes first index information and second index information, the first index information is used to indicate the first segment, and the second index information is used to indicate the second segment, where
the second index information is the same as the first index information in a case that the second segment and the first segment are duplicate segments.

According to a third aspect, an embodiment of this application further provides a media file play apparatus, and the apparatus includes:
a sending module, configured to send a first request message to a server, where the first request message is used to request to play a target media file, the target media file includes a first segment and a second segment, and a play sequence of the first segment is earlier than a play sequence of the second segment;
a receiving module, configured to receive a target configuration file sent by the server, where the target configuration file includes at least first index information and second index information, the first index information is used to indicate the first segment, and the second index information is used to indicate the second segment; and
a play module, configured to: after the first segment is obtained from the server based on the first index information, cache and play the first segment, and associate the first index information with the cached first segment; and retrieve cache content based on the second index information, and play the cached first segment in a case that the second index information is the same as the first index information.

According to a fourth aspect, an embodiment of this application further provides a media file play apparatus, and the apparatus includes:
a receiving module, configured to receive a first request message sent by an electronic device, where the first request message is used to request to play a target media file, the target media file includes a first segment and a second segment, and a play sequence of the first segment is earlier than a play sequence of the second segment; and
a sending module, configured to send a target configuration file to the electronic device based on the first request message, where the target configuration file includes first index information and second index information, the first index information is used to indicate the first segment, and the second index information is used to indicate the second segment, where the second index information is the same as the first index information in a case that the second segment and the first segment are duplicate segments.

According to a fifth aspect, an embodiment of this application provides an electronic device. The electronic device includes a processor, a memory, and a program or an instruction that is stored in the memory and that can be run on the processor, where when the program or the instruction is executed by the processor, the steps of the method in the first aspect are implemented.

According to a sixth aspect, an embodiment of this application provides a server, where a program or an instruction is stored on the server, and the program or the instruction is executed by a processor to implement the steps of the method in the second aspect.

According to a seventh aspect, an embodiment of this application provides a readable storage medium, where a computer program is stored in the readable storage medium, and the computer program is executed by a processor to implement the steps of the media file play method in the first aspect or the second aspect.

According to an eighth aspect, an embodiment of this application provides a chip, where the chip includes a processor and a communication interface, the communication interface is coupled to the processor, and the processor is configured to run a program or an instruction to implement the method in the first aspect or the second aspect.

In the embodiments of this application, a server stores a target configuration file corresponding to a target media file, where the target media file includes a plurality of segments, and the plurality of segments include a first segment and a second segment; and the target configuration file includes a plurality of pieces of index information, the plurality of pieces of index information include first index information and second index information, and the first index information and the second index information are respectively used to indicate the first segment and the second segment in the target media file, where a play sequence of the first segment is earlier than a play sequence of the second segment. When an electronic device requests the server to play the target media file, after downloading the first segment from the server and playing the first segment based on the first index information, the electronic device may cache the first segment in a cache apparatus of the electronic device. When the second segment is played, if index information of the second segment is the same as index information of the first segment, that is, the second index information is the same as the first index information, it indicates that the second segment and the first segment are duplicate segments with duplicate content. Therefore, the electronic device does not need to download the second segment from the server again, but only needs to retrieve, from the cache apparatus of the electronic device based on the first index information, the first segment associated with the first index information, and play the first segment, to achieve a purpose of playing the second segment, without requiring the electronic device to download the second segment that duplicates the first segment from the server again. In this way, in a process of playing the target media file with duplicate segments, the electronic device does not need to repeatedly download the content duplicate segments from the server, thereby saving traffic of playing the media file with duplicate segments.

### BRIEF DESCRIPTION OF DRAWINGS

FIG. 1 is a schematic architectural diagram of a communication system according to an embodiment of this application;

FIG. 2 is a first schematic interaction diagram of a media file play method according to an embodiment of this application;

FIG. 3 is a second schematic interaction diagram of a media file play method according to an embodiment of this application;

FIG. 4 is a third schematic interaction diagram of a media file play method according to an embodiment of this application;

FIG. 5 is a first schematic diagram of an operation in which a target media file is divided into segments according to an embodiment of this application;

FIG. 6 is a second schematic diagram of an operation in which a target media file is divided into segments according to an embodiment of this application;

FIG. 7 is a third schematic diagram of an operation in which a target media file is divided into segments according to an embodiment of this application;

FIG. 8 is a fourth schematic interaction diagram of a media file play method according to an embodiment of this application;

FIG. 9 is a fifth schematic interaction diagram of a media file play method according to an embodiment of this application;

FIG. 10 is a flowchart of a media file play method performed by an electronic device according to an embodiment of this application;

FIG. 11 is a flowchart of a media file play method performed by a server according to an embodiment of this application;

FIG. 12 is a first schematic structural diagram of a media file play apparatus according to an embodiment of this application;

FIG. 13 is a second schematic structural diagram of a media file play apparatus according to an embodiment of this application;

FIG. 14 is a first schematic structural diagram of another media file play apparatus according to an embodiment of this application;

FIG. 15 is a second schematic structural diagram of another media file play apparatus according to an embodiment of this application;

FIG. 16 is a third schematic structural diagram of another media file play apparatus according to an embodiment of this application;

FIG. 17 is a schematic diagram of hardware of an electronic device according to an embodiment of this application; and

FIG. 18 is a schematic diagram of hardware of a server according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

In the specification and claims of this application, the terms “first”, “second”, and the like are intended to distinguish between similar objects but do not describe a specific order or sequence. It should be understood that the data used in such a way is interchangeable in proper circumstances so that the embodiments of this application can be implemented in an order other than the order illustrated or described herein. In addition, in the specification and the claims, “and/or” represents at least one of connected objects, and a character “/” generally represents an “or” relationship between associated objects.

It should be noted that, in the embodiments of this application, the words “for example” or “such as” are used to mean an example, an illustration, or a description. Any embodiment or design scheme described as “an example of” or “for example” in the embodiments of this application should not be explained as being more preferred or having more advantages than another embodiment or design scheme. Exactly, use of the term “example” or “for example” is intended to present a concept in a specific manner.

A media file play method provided in the embodiments of this application may be performed by a media file play apparatus. The apparatus may be the foregoing electronic device (including a mobile electronic device and a non-mobile electronic device), a server that establishes a connection to the foregoing electronic device, or a function module and/or a function entity in the electronic device and the server and can implement the media file play method. In some embodiments, this may be determined according to an actual use requirement, and is not limited in the embodiments of this application. The media file play method provided in the embodiments of this application may be applied to a scene in which the electronic device requests a server to play a media file with duplicate segments, for example, a scene in which the electronic device requests the server to play a media file with synchronously duplicate audio and video, or a scene in which the electronic device requests the server to play a media file with asynchronously duplicate audio and video.

In the embodiments of this application, a server stores a target configuration file corresponding to a target media file, where the target media file includes a plurality of segments, and the plurality of segments include a first segment and a second segment; and the target configuration file includes a plurality of pieces of index information, the plurality of pieces of index information include first index information and second index information, and the first index information and the second index information are respectively used to indicate the first segment and the second segment in the target media file, where a play sequence of the first segment is earlier than a play sequence of the second segment. When an electronic device requests the server to play the target media file, after downloading the first segment from the server and playing the first segment based on the first index information, the electronic device may cache the first segment in a memory of the electronic device. When the second segment is played, if index information of the second segment is the same as index information of the first segment, that is, the second index information is the same as the first index information, it indicates that the second segment and the first segment are duplicate segments with duplicate content. Therefore, the electronic device does not need to download the second segment from the server again, but only needs to retrieve, from the memory of the electronic device based on the first index information, the first segment associated with the first index information and play the first segment, to achieve a purpose of playing the second segment, without requiring the electronic device to download the second segment that duplicates the first segment from the server again. In this way, in a process of playing the target media file with duplicate segments, the electronic device does not need to repeatedly download the duplicate segments from the server, thereby saving traffic of playing the media file with duplicate segments.

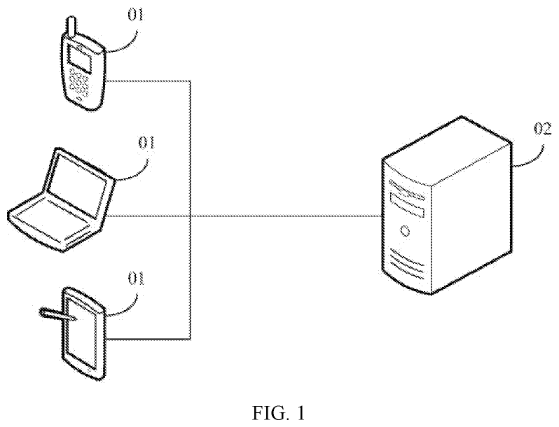

With reference to FIG. 1 to FIG. 17, the following describes in detail the media file play method and apparatus, the electronic device, and the server provided in the embodiments of this application by using specific embodiments and application scenes.

For example, FIG. 1 is a schematic architectural diagram of a communication system according to an embodiment of this application. As shown in FIG. 1, the communication system may include at least one electronic device 01 and a server 02. The at least one electronic device 01 and the server 02 may establish a connection and communicate with each other.

FIG. 1 is an example in which the at least one electronic device 01 and the server 02 are connected through a wired network, and does not impose any limitation on this embodiment of this application. It can be understood that, in actual implementation, the at least one electronic device 01 and the server 02 may be connected through a wireless network. This may be determined according to an actual use requirement.

In this embodiment of this application, the server may be a computer device that manages resources and provides a service for the electronic device. The server may include a processor, a hard disk, a memory, a bus, and the like.

In this embodiment of this application, the electronic device may send, to the server, a first request message for requesting to play a target media file. After receiving the first request message, the server may first send a target configuration file including index information of each segment in the target media file to the electronic device, that is, the electronic device obtains the target configuration file sent by the server, and then the electronic device may obtain a cached segment from the electronic device based on the index information in the target configuration file, or download, from the server, a segment that is not cached in the electronic device.

In this embodiment of this application, the electronic device may be a mobile electronic device, or may be a non-mobile electronic device. The mobile electronic device may be a mobile phone, a tablet computer, a laptop computer, a palmtop computer, an in-vehicle electronic device, a wearable device, an ultra-mobile personal computer (UMPC), a netbook, a personal digital assistant (PDA), or the like. The non-mobile electronic device may be a personal computer (PC), a television (TV), an automated teller machine, a self-service machine, or the like. This is not specifically limited in this embodiment of this application.

The electronic device in this embodiment of this application may be an electronic device with an operating system. The operating system may be an Android operating system, an iOS operating system, or another operating system. This is not specifically limited in this embodiment of this application.

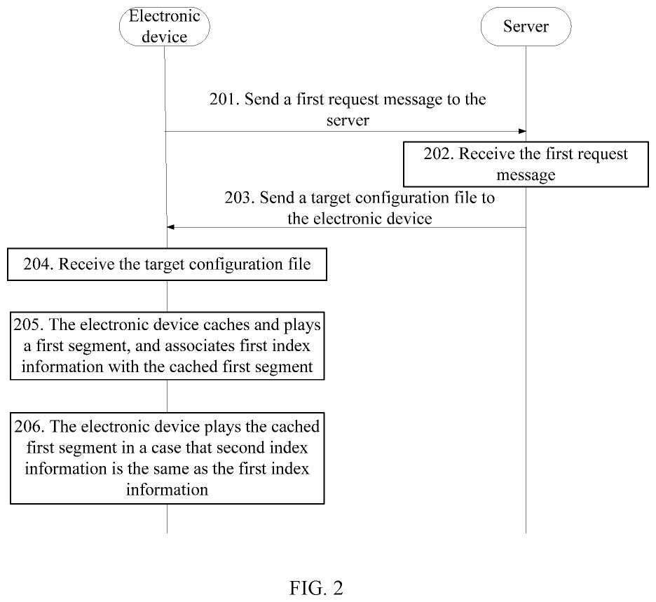

Based on the communication system shown in FIG. 1, an embodiment of this application provides a media file play method, and the media file play method may be implemented through information exchange between the electronic device 01 and the server 02 in the communication system shown in FIG. 1. The following describes the media file play method provided in this embodiment of this application by using an example in which the media file play apparatus is an electronic device and a server. As shown in FIG. 2, the media file play method may include the following step 201 to step 206.

Step 201: An electronic device sends a first request message to a server.

The first request message is used to request to play a target media file, the target media file includes a first segment and a second segment, and a play sequence of the first segment is earlier than a play sequence of the second segment.

The first request message may be used to request to play the target media file. It can be understood that the first request message may be used by the electronic device to request the target media file from the server.

In this embodiment of this application, the electronic device may send the first request message to the server in the following two manners:

In a first manner, the electronic device may send the first request message to the server based on a play request operation performed by a user and in response to the play request operation. That is, the electronic device may send the first request message to the server when triggered by the user.

For example, the first request message may be sent when the user triggers the play request operation on the target media file in a target application. For example, the first request message may be sent when the user triggers an operation on a play key on a play interface of the target application.

In this embodiment of this application, the target application may be a multimedia application in the electronic device, such as a video application, an audio application, or another application that may play an audio file and/or a video file. This may be determined according to an actual use requirement, and is not limited in this embodiment of this application.

In a second manner, the electronic device may automatically send the first request message to the server.

For example, the electronic device may be installed with a video application. After entering a play interface of the video application, the electronic device automatically plays a recommended video on the play interface. That is, after entering the play interface, the electronic device automatically sends, to the server, the first request message for playing the recommended video.

In this embodiment of this application, the target media file may be an audio media file (that is, include audio), a video media file (that is, include a video), or an audio and video media file (that is, include audio and a video).

In this embodiment of this application, the target media file may include a plurality of segments, and the plurality of segments include at least the first segment and the second segment. The play sequence of the first segment is earlier than the play sequence of the second segment, that is, the second segment is played only after the electronic device plays the first segment.

In this embodiment of this application, the first segment and the second segment may be content duplicate segments, or may be segments with different content.

In this embodiment of this application, in a case that the target media file is an audio media file (that is, includes only audio), the first segment and the second segment are also an audio media file. In a case that the target media file is a video media file (that is, includes only a video), the first segment and the second segment are also a video media file. In a case that the target media file is an audio and video media file (that is, includes audio and a video), the first segment and the second segment are also an audio and video media file.

Step 202: The server receives the first request message.

In this embodiment of this application, after the electronic device sends the first request message to the server, the server may receive the first request message sent by the electronic device. After the server receives the first request message, the server may obtain, based on the first request message, a target configuration file of the target media file indicated by the first request message.

A method for obtaining the target configuration file of the target media file by the server is described in detail in the following embodiment, and details are not described herein.

Step 203: The server sends a target configuration file to the electronic device.

The target configuration file includes first index information and second index information, the first index information is used to indicate the first segment, and the second index information is used to indicate the second segment.

In this embodiment of this application, the server may store a plurality of media files, each media file is configured with a configuration file, and these configuration files are all stored in the server. When the electronic device requests the server to play a media file such as the target media file, the server may first send the target configuration file corresponding to the target media file to the electronic device in response to a play request of the electronic device for the target media file.

In this embodiment of this application, the target configuration file may include a plurality of pieces of index information, the plurality of pieces of index information include at least the first index information and the second index information, and each piece of index information may be used to indicate one segment in the target media file. For example, the first index information is used to indicate the first segment and the second index information is used to indicate the second segment. The target configuration file may be used by the electronic device to download each segment of the target media file from the server before playing the target media file.

In this embodiment of this application, in an implementation, the server may perform slice processing on the target media file to obtain a plurality of slice files (for example, the first segment and the second segment in this embodiment of this application), and the server configures one piece of index information for each segment. Then, the server may splice the plurality of pieces of index information into one list file (for example, the target configuration file in this embodiment), and store the target configuration file in the server.

In another implementation, the server may further receive the target configuration file uploaded by a media file provider. In some embodiments, the electronic device of the media file provider may first perform slice processing on the target media file to obtain a plurality of slice files (for example, the first segment and the second segment in this embodiment of this application), and the electronic device of the media file provider configures one piece of index information for each of the plurality of segments, and then splices the plurality of pieces of index information into one list file (for example, the target configuration file in this embodiment). Then, the electronic device of the media file provider may upload the target configuration file to the server, and after receiving the target configuration file, the server may store the target configuration file in the server.

In still another implementation, the electronic device of a media file provider may first perform slice processing on the target media file to obtain a plurality of slice files (for example, the first segment and the second segment in this embodiment of this application), and then send the plurality of segments to the server. After receiving the plurality of segments, the server configures one piece of index information for each segment. Then, the server may splice the plurality of pieces of index information into one list file (for example, the target configuration file in this embodiment), and store the target configuration file in the server.

In this embodiment of this application, the target configuration file may be configured as a file in an M3U8 format. The M3U8 file is essentially an M3U file (Moving Picture Experts Group Audio Layer 3 Uniform Resource Locator), and the M3U file is similar to directory information of an audio file, a video file, and an audio and video file.

It should be noted that the M3U8 file is not an audio file, a video file, or an audio and video file, but a list file of an audio file, a video file, and an audio and video file. After the electronic device opens the M3U8 file, the electronic device does not directly play the M3U8 file, but first obtains corresponding index information based on the M3U8 file, and then downloads and plays a corresponding segment.

In this embodiment of this application, the plurality of pieces of index information are greater than or equal to two pieces of index information.

In this embodiment of this application, the index information may be a Uniform Resource Locator (URL), and the URL is used to locate a resource by using an abstract identifier that provides a resource location. The index information may be storage path information, or index information in any other form. This may be determined according to an actual use requirement, and is not limited in this embodiment of this application.

It can be understood that, in this embodiment of this application, the foregoing same index information may be understood as that key values of URLs are the same, that is, URLs that have a same key are used to locate a same address; or the foregoing same index information may be understood as same storage path information.

Step 204: The electronic device receives the target configuration file.

In this embodiment of this application, after the electronic device receives the target configuration file sent by the server, the electronic device may play, based on index information in the target configuration file, segments indicated by the index information. In some embodiments, the electronic device may download and play the first segment from the server based on the first index information in the target configuration file, and the electronic device may further download and play the second segment from the server based on the second index information.

Step 205: The electronic device caches and plays a first segment, and associates first index information with the cached first segment.

In this embodiment of this application, the electronic device may download the first segment from the server based on the first index information in the received target configuration file, cache the first segment in a local cache apparatus of the electronic device, and associate the first index information with the cached first segment, so that the electronic device can retrieve the first segment based on the first index information, and can read the first segment at any time.

In this embodiment of this application, the electronic device may include a cache apparatus. The cache apparatus may be a static memory (SRAM), also referred to as a random memory, and stores data (for example, index information or a segment) or an instruction (for example, an instruction for playing a segment or an instruction for reading a segment) rapidly.

In this embodiment of this application, after receiving the first segment, the electronic device may cache the first segment in the electronic device.

In this embodiment of this application, after playing the first segment, the electronic device may cache the first segment in the electronic device.

In this embodiment of this application, the electronic device may further cache a text indicating an association between the first segment and the first index information in the cache apparatus.

Step 206: The electronic device plays the cached first segment in a case that second index information is the same as the first index information.

In this embodiment of this application, the electronic device may determine, based on the second index information, whether segments of same content have been cached in the electronic device. If there is index information (the first index information in this embodiment) that is the same as the second index information in the cache apparatus of the electronic device, it indicates that a segment that has the same content as the second segment exists in the electronic device, and the segment (the first segment in this embodiment) is cached in the local cache apparatus, the electronic device directly reads the cached first segment from the cache apparatus and plays the cached first segment based on the first index information that is the same as the second index information.

According to the media file play method provided in this embodiment of this application, after an electronic device sends, to a server, a first request message for playing a target media file, the server may send a target configuration file corresponding to the target media file, where the target media file includes a plurality of segments, and the plurality of segments include a first segment and a second segment; and the target configuration file includes a plurality of pieces of index information, the plurality of pieces of index information include first index information and second index information, and the first index information and the second index information are respectively used to indicate the first segment and the second segment in the target media file, where a play sequence of the first segment is earlier than a play sequence of the second segment. When playing the target media file, the electronic device can play the target media file in segments. When the second segment and the first segment have duplicate content, the electronic device does not download the second segment from the server, but reads the cached first segment from a cache apparatus of the electronic device. Therefore, when there are duplicate segments in the target media file, if duplicate segments have been cached in the electronic device, the electronic device does not need to repeatedly download the duplicate segments from the server, thereby avoiding a waste of traffic when the electronic device plays a media file, and improving efficiency of playing the media file by the electronic device.

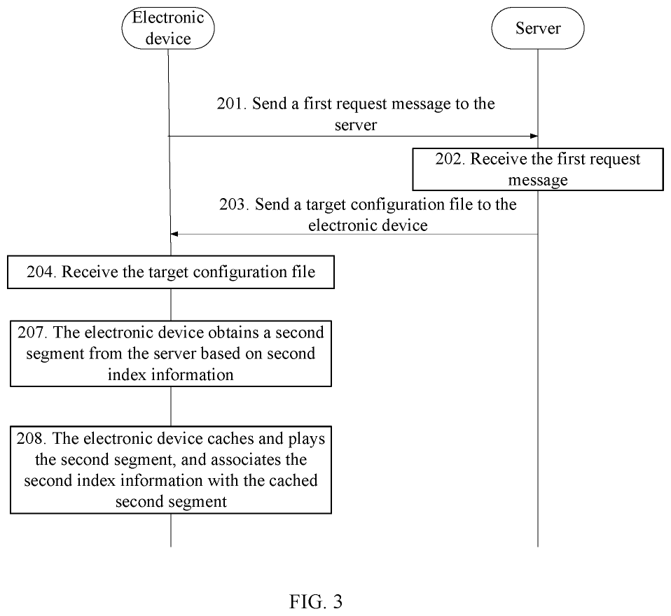

In this embodiment of this application, as shown in FIG. 3, in a case that the second index information is different from the first index information, the media file play method provided in this embodiment of this application may further include the following steps 207 to 208.

Step 207: The electronic device obtains a second segment from the server based on the second index information.

In this embodiment, the electronic device may determine, based on the second index information, whether segments of same content have been cached in the electronic device. If the electronic device determines, based on the second index information, that no segment that has the same index information as the second index information has been cached, the electronic device may download the second segment from the server.

It can be understood that when the electronic device performs retrieval based on the second index information, if no index information that is the same as the second index information is retrieved, it indicates that there is no cached segment that duplicates the second segment in the electronic device. If the electronic device needs to play the second segment, the second segment needs to be downloaded from the server before playing.

Step 208: The electronic device caches and plays the second segment, and associates the second index information with the cached second segment.

In this embodiment of this application, after playing the second segment, the electronic device caches the second segment in the cache apparatus of the electronic device. After the second segment is cached, the electronic device may establish an association between the second index information and the second segment, so that the electronic device can directly read the second segment from the local cache apparatus when playing a segment that is behind the second segment and whose content duplicates that of the second segment, and does not need to download the duplicate segments from the server again.

In this embodiment of this application, after receiving the second segment, the electronic device may cache the second segment in the electronic device.

In this embodiment of this application, after playing the second segment, the electronic device may cache the second segment in the electronic device.

In this embodiment of this application, the electronic device may further cache an association text between the second segment and the second index information in the cache apparatus.

According to the media file play method provided in this embodiment of this application, only when a segment indicated by index information that is the same as the second index information is not cached in the cache apparatus of the electronic device, that is, when no duplicate segment of the second segment is cached in the cache apparatus of the electronic device, the electronic device needs to obtain the second segment from the server, and plays the second segment. Therefore, the electronic device can determine, based on whether the cache apparatus of the electronic device stores a duplicate segment whose content is the same as that of the second segment, whether to download the second segment from the server, so that a waste of traffic caused by downloading the duplicate segments from the server by the electronic device in response to a play request of the user can be avoided.

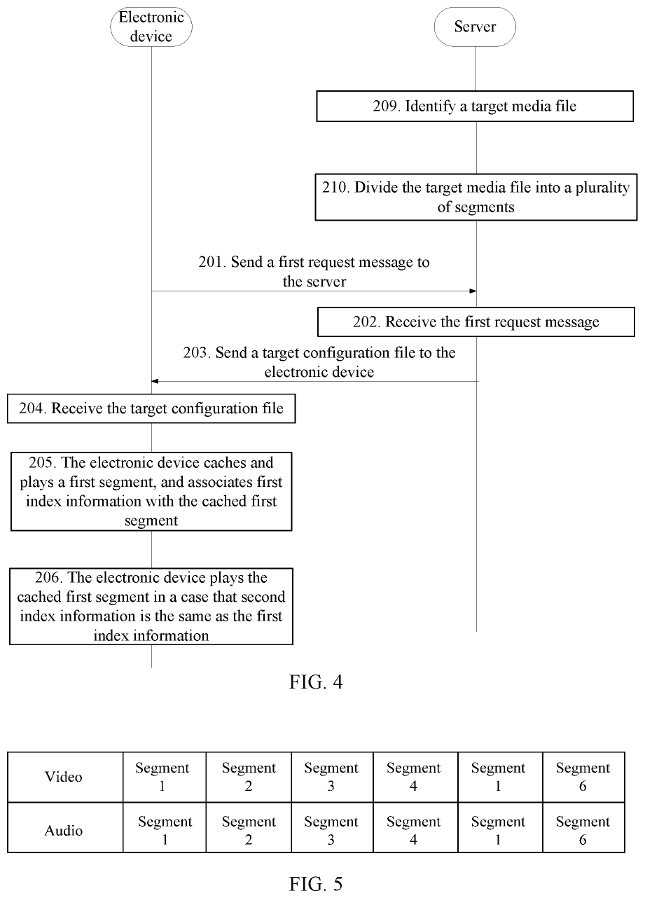

In this embodiment of this application, with reference to FIG. 2, as shown in FIG. 4, before the server receives the first request message sent by the electronic device, the media file play method provided in this embodiment of this application may further include the following steps 209 to 210.

Step 209: The server identifies the target media file.

In this embodiment of this application, after receiving the target media file uploaded by the media file provider, the server may perform an identification operation on the target media file. In some embodiments, the server identifies whether there are duplicate segments in the target media file. If there are duplicate segments, step 210 is performed.

Step 210: The server divides the target media file into a plurality of segments.

The plurality of segments include the first segment and the second segment.

In this embodiment of this application, the server may divide the target media file into a plurality of segments based on scene content of the target media file.

For example, in a case that the target media file is a video file, if there are duplicate segments in the target media file, for example, when the target media file is a sports tutorial media file, because most scene content is duplicate actions in beats, the server may divide each duplicate action segment into one video segment based on content of the target media file, for example, the first segment and the second segment.

For example, in a case that the target media file is an audio file, if there are duplicate audio segments in the target media file, for example, the target media file is a white noise media file with duplicate audio content, the server may divide each duplicate audio segment into one audio segment based on content of the target media file, for example, the first segment and the second segment.

For example, in a case that the target media file is an audio and video file, if there are synchronously duplicate segments in audio and a video in the target media file, for example, when the target media file is a landscape media file with synchronously duplicate audio and video content, the server may divide each segment with synchronously duplicate audio and video into one audio and video segment based on content of the target media file, for example, the first segment and the second segment.

In some embodiments, the foregoing step 210 may be implemented by the following step 210a.

Step 210a: If duration of the duplicate segment in the target media file is greater than or equal to a preset threshold, the server divides the target media file into the first segment and the second segment.

In this embodiment of this application, the duration of the duplicate segment may be duration required for entirety playing the duplicate segment.

For example, as shown in FIG. 5, one target media file is divided into a plurality of segments, and the target media file includes synchronously duplicate segments in audio and a video. For example, the target media file is divided into six segments, and the 5th segment and the 1st segment are synchronously duplicate segments in audio and a video. If duration of the 1st segment or the 5th segment is greater than or equal to a preset threshold, the server determines that duplicate scene content of the 1st segment or the 5th segment is long, and it indicates that the electronic device needs to consume much traffic to download the duplicate segments from the server. Therefore, the target media file needs to be divided into a plurality of segments, and the electronic device does not need to repeatedly download the duplicate segments from the server when playing the duplicate segments.

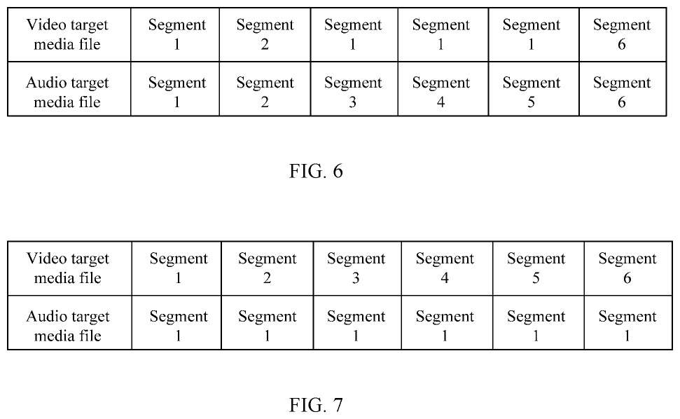

It can be understood that when the target media file is an audio file or a video file, a division manner thereof is the same as a division manner when the target media file is an audio and video file. For example, as shown in FIG. 6, one target media file is divided into a plurality of segments when the target media file is a video target media file. The target media file includes duplicate video segments. For example, the target media file is divided into six segments, and the 3rd segment, the 4th segment, and the 5th segment are duplicate video segments. If duration of the 3rd segment, the 4th segment, and the 5th segment is greater than or equal to a preset threshold, the server determines that duplicate scene content of the 3rd segment, the 4th segment, and the 5th segment is long, and the electronic device needs to consume much traffic to download the duplicate segments from the server. Therefore, slice processing needs to be performed on the target media file to be divided into a plurality of segments, and the electronic device does not need to repeatedly download the duplicate segments from the server when playing the duplicate segments.

For example, as shown in FIG. 7, one target media file is divided into a plurality of segments when the target media file is an audio target media file. The target media file includes duplicate audio segments. For example, the target media file is divided into six segments, and content of each of the six segments is the same, that is, the six segments are duplicate audio segments. If duration of the six segments is greater than or equal to a preset threshold, the server determines that duplicate scene content of the six segments is long, and the electronic device needs to consume much traffic to download the duplicate segments from the server. Therefore, the target media file needs to be divided into a plurality of segments, and the electronic device does not need to repeatedly download the duplicate segments from the server when playing the duplicate segments.

According to the media file play method provided in this embodiment of this application, the server may perform slice processing on the target media file by identifying duplicate segments in the target media file, to divide the target media file into a plurality of segments, and configure the corresponding first index information and the second index information, and the electronic device does not need to repeatedly download the duplicate segments from the server when playing the duplicate segments, so that the electronic device can save traffic when playing the target media file.

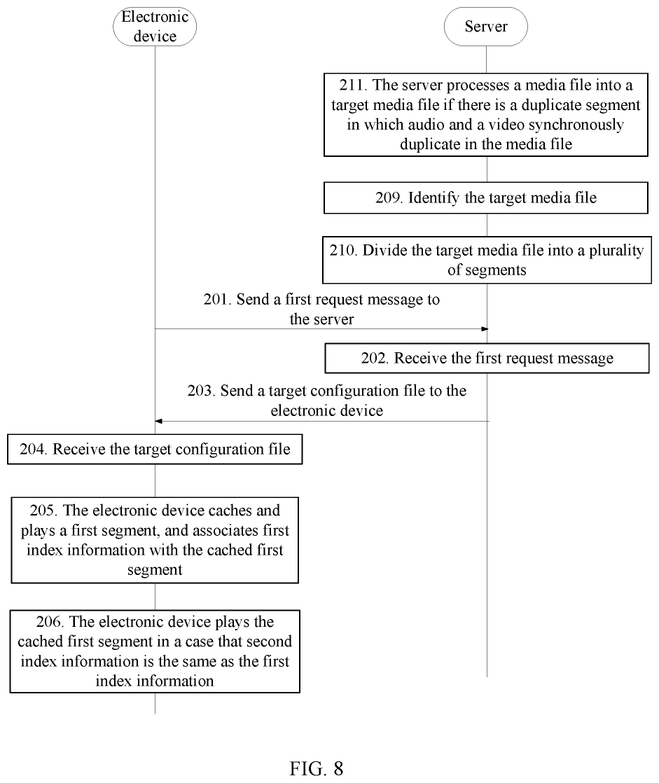

In this embodiment of this application, with reference to FIG. 4, as shown in FIG. 8, before the server identifies the target media file, the media file play method provided in this embodiment of this application may further include the following step 211.

Step 211: If there are synchronously duplicate segments in audio and a video in a media file, the server processes the media file into one target media file.

In this embodiment of this application, the media file may be a media file with synchronously duplicate audio and video. When the audio and the video synchronously duplicate, the server uses the media file as one target media file, that is, the server uses the media file as one target media file, and configures one target configuration file, that is, one M3U8 file, for the target media file.

It should be noted that “synchronously duplicate segments in audio and a video” means that video content of at least two segments in a plurality of segments in the media file is the same, and audio content is also the same. In this embodiment of this application, duration of the foregoing “synchronously duplicate segments in audio and a video” may also be greater than or equal to a preset threshold. When the duration of the duplicate segments is long, it indicates that the server needs to use the media file as the target media file for slice processing. If the duration of the synchronously duplicate segments in the audio and the video is very short, the electronic device consumes less traffic to download the duplicate segments from the server, and the server does not need to use the media file as the target media file for slice processing.

In this embodiment of this application, if duration of the “synchronously duplicate segments in audio and a video” is less than a preset threshold, and the audio or the video in the media file is separately duplicated, the server may split the audio and the video in the media file into two target media files, and then perform slice processing on each target media file.

According to the media file play method provided in this embodiment of this application, in a case that there are synchronously duplicate segments in audio and a video in the media file, the media file is processed into one target media file, so that the electronic device simultaneously plays the audio and the video of the target media file by using one player.

In this embodiment of this application, the media file play method provided in this embodiment of this application may further include the following step 212.

Step 212: The electronic device starts a first player to play a first segment and a second segment of one target media file based on a target configuration file of the target media file.

In this embodiment of this application, the first player may be used to play a video and audio of the target media file (that is, the player may play both the audio of the target media file and the video of the target media file).

In this embodiment of this application, the first segment and the second segment are audio and video segments. The first player may play the first segment and the second segment of the target media file.

It can be understood that, in this embodiment, when the electronic device plays the first segment and the second segment based on the first index information and the second index information by using the first player, if the second index information is the same as the first index information, it indicates that content of the second segment is the same as that of the first segment, the electronic device does not download the second segment from the server, but reads the cached first segment from the cache apparatus of the electronic device, and plays the first segment by using the first player. A method for playing the first segment and the second segment by the electronic device based on the first index information and the second index information in the target configuration file is described in detail in the foregoing embodiment, and details are not described herein again.

According to the media file play method provided in this embodiment of this application, the electronic device plays, by using one player, the first segment and the second segment in the target media file that are indicated by first index information and second index information, to ensure sound and picture synchronization when the target media file is played on the basis of saving player resources, thereby improving play efficiency of the terminal device.

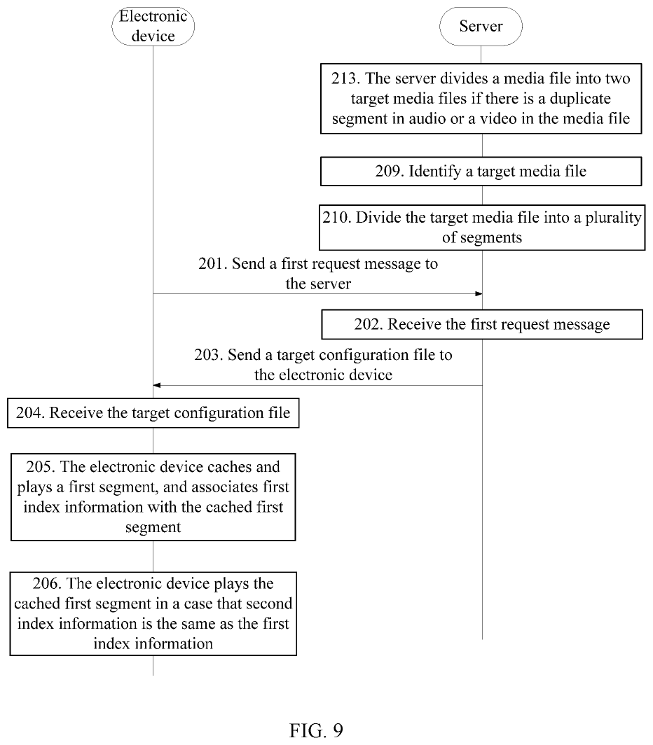

In this embodiment of this application, with reference to FIG. 4, as shown in FIG. 9, before the server identifies the target media file, the media file play method provided in this embodiment of this application may further include the following step 213.

Step 213: If there are duplicate segments in audio or a video in a media file, the server processes the media file into two target media files.

One of the two target media files is an audio file, and the other of the two target media files is a video file.

In this embodiment of this application, the media file may be a media file in which there are duplicate segments in audio or a video. When there are duplicate segments in the audio or the video, the server splits the media file into two target media files, where one is an audio file, that is, an audio target media file, and the other is a video file, that is, a video target media file. The server splits the media file into two target media files, and each target media file includes a first segment and a second segment. The server may also separately configure two target configuration files for the two target media files, that is, the server separately configures two M3U8 files for the two target media files, where each M3U8 file includes first index information and second index information, the first index information in each M3U8 file is used to indicate a first segment in the M3U8 file, and the second index information is used to indicate a second segment in the M3U8 file.

It should be noted that a data frame of the media file may have a type identifier. It may be determined, based on these identifiers, that the data frame is an audio data frame or a video data frame. In this embodiment of this application, the media file may include both an audio data frame and a video data frame. The server may separately extract the audio data frame and the video data frame from the media file. The extracted audio data frame may be generated as one target media file, that is, the foregoing audio target media file. The extracted video data frame may be generated as one target media file, that is, the foregoing video target media file.

In this embodiment of this application, when the server is requested by the electronic device to play the media file, if the server splits the media file into two target media files, the server sends a corresponding identifier to the electronic device, and the electronic device simultaneously sends two first request messages to the server based on the identifier, so that the electronic device can separately play the two target media files by using different players.

In this embodiment of this application, target configuration files of the two target media files may be different configuration files. That is, first index information of the audio target media file and first index information of the video target media file may be different index information, and second index information of the audio target media file and second index information of the video target media file may be different index information.

For example, “there are duplicate segments in audio or a video” means that there are duplicate segments in the audio in the media file, there are duplicate segments in the video in the media file, or there are duplicate segments in the audio and the video in the media file, but duplication of the audio and the video is not synchronized. As shown in FIG. 8, content of the 3rd segment to the 5th segment of the video target media file is duplicate, but content of the 3rd segment to the 5th segment of the audio target media file is different.

According to the media file play method provided in this embodiment of this application, the server splits the media file into two target media files: an audio target media file and a video target media file, where one or two target media files include duplicate segments, so that slice processing can be separately performed on the two target media files based on an actual situation of the media file, thereby saving traffic of downloading the duplicate segments.

In this embodiment of this application, the media file play method provided in this embodiment of this application may further include the following step 214.

Step 214: The electronic device starts a second player to play a first segment and a second segment in one target media file based on a target configuration file of the one target media file, and the electronic device starts a third player to play a first segment and a second segment in the other target media file based on a target configuration file of the other target media file.

In this embodiment of this application, when a media file is split into two target media files, the electronic device may start two players to separately play the two target media files.

For example, in this embodiment of this application, as shown in FIG. 6, the server splits a media file into two target media files, where one target media file is a video target media file, and the other target media file is an audio target problem file. The electronic device plays the video target media file by using the second player, and plays the audio target media file by using the third player. When the electronic device plays the 1st segment (the first segment in this embodiment) and the 2nd segment based on a target configuration file of the video target media file by using the second player, because the electronic device does not cache a same video segment, the 1st segment and the 2nd segment need to be requested to be downloaded from the server. When the second player plays the 3rd segment (the second segment in this embodiment), index information of the 3rd segment is the same as that of the 1st segment, file content is a segment 1, and because the segment 1 has been played before, the segment 1 is directly read from the cache apparatus and played. When playing the 4th segment and the 5th segment by using the second player, the electronic device directly reads the segment 1 from the cache apparatus and plays the segment 1. Because index information of six segments in the audio target media file is different, and content of the indicated segments is also different, when the third player plays the six segments of the audio target media file based on a target configuration file of the audio target media file, the six segments need to be downloaded from the server.

It should be noted that duration and a quantity of segments in the video target media file may be the same as or different from duration and a quantity of segments in the audio target media file.

For example, in this embodiment of this application, as shown in FIG. 7, the server splits a media file into two target media files, where one target media file is a video target media file, and the other target media file is an audio target problem file. The electronic device plays the video target media file by using the second player, and plays the audio target media file by using the third player. When the electronic device plays six segments based on a target configuration file of the video target media file by using the second player, index information of the six segments is different, and content of the indicated segments is also different. Therefore, when the second player plays the six segments, the electronic device needs to request to download the six segments from the server. When the electronic device plays six segments based on a target configuration file of the audio target media file by using the third player, index information of the 1st segment (the first segment in this embodiment) to a sixth segment (the second segment in this embodiment) is the same, and file content is a segment 1. Only the 1st segment needs to be downloaded from the server, and when the remaining five segments need to be played, the segment 1 is directly read from the cache apparatus of the electronic device and played.

According to the media file play method provided in this embodiment of this application, two target media files are separately played by the electronic device by using two players. The electronic device may separately read duplicate segments for play from the cache apparatus of the electronic device based on duplicate situations of the audio and the video in the media file, thereby saving traffic of downloading the duplicate segments by the electronic device based on the respective duplicate situations of the audio and the video in the media file.

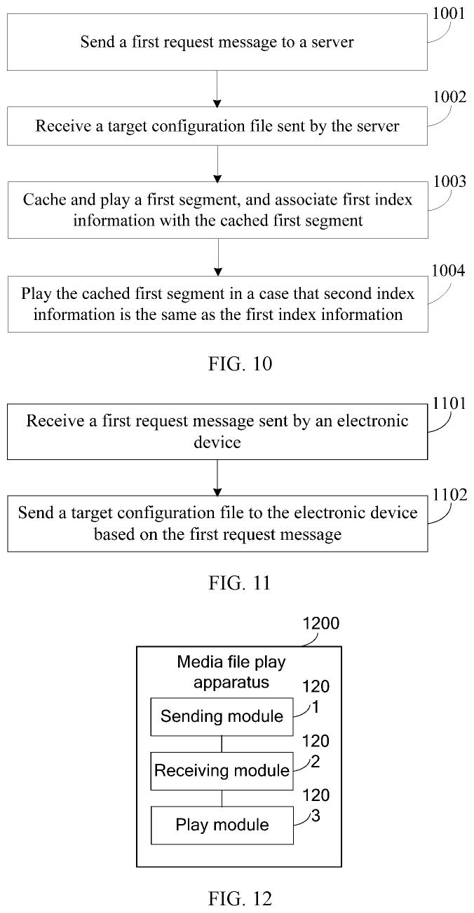

As shown in FIG. 10, an embodiment of this application provides a media file play method. The method is performed by an electronic device, and the method includes:

Step 1001: Send a first request message to a server.

The first request message is used to request to play a target media file, the target media file includes a first segment and a second segment, and a play sequence of the first segment is earlier than a play sequence of the second segment.

Step 1002: Receive a target configuration file sent by the server.

The target configuration file includes first index information and second index information, the first index information is used to indicate the first segment, and the second index information is used to indicate the second segment.

Step 1003: Cache and play a first segment, and associate first index information with the cached first segment.

Step 1004: Play the cached first segment in a case that second index information is the same as the first index information.

In a case that the second index information is different from the first index information, the foregoing method further includes step 1005 to step 1006:

Step 1005: Obtain a second segment from the server based on the second index information.

Step 1006: Cache and play the second segment, and associate the second index information with the buffered second segment.

In some embodiments, the foregoing method further includes step 1007:

Step 1007: Start a first player to play the first segment and the second segment based on the first index information and the second index information.

In some embodiments, the foregoing method further includes step 1008:

Step 1008: Start a second player to play a first segment and a second segment in one target media file based on a target configuration file of the one target media file, and start a third player to play a first segment and a second segment in the other target media file based on a target configuration file of the other target media file.

For descriptions of step 1001 to step 1008 in the media file play method provided in this embodiment of this application, refer to the related descriptions of the steps performed by the electronic device and the achieved effects in the foregoing embodiment. To avoid repetition, details are not described herein again.

As shown in FIG. 11, an embodiment of this application provides a media file play method. The method is performed by a server, and the method includes:

Step 1101: Receive a first request message sent by an electronic device.

The first request message is used to request to play a target media file, the target media file includes a first segment and a second segment, and a play sequence of the first segment is earlier than a play sequence of the second segment.

Step 1102: Send a target configuration file to the electronic device based on the first request message.

The target configuration file includes first index information and second index information, the first index information is used to indicate the first segment, and the second index information is used to indicate the second segment.

In some embodiments, before step 1101, the foregoing method further includes:

Step 1103: Identify a target media file.

Step 1104: Divide the target media file into a plurality of segments.

The plurality of segments include the first segment and the second segment.

In some embodiments, step 1104 includes step 1104a:

Step 1104a: If duration of a duplicate segment in the target media file is greater than or equal to a preset threshold, divide the target media file into a first segment and a second segment.

In some embodiments, before step 1103, the foregoing method further includes:

Step 1105: If there are synchronously duplicate segments in audio and a video in a media file, the server processes the media file into one target media file.

In some embodiments, before step 1103, the foregoing method further includes:

Step 1106: If there are duplicate segments in audio or a video in a media file, process the media file into two target media files, where one of the two target media files is an audio file, and the other of the two target media files is a video file.

According to the media file play method provided in this embodiment of this application, for descriptions of step 1101 to step 1106, refer to the related descriptions of the steps performed by the server and the achieved effects in the foregoing embodiment. To avoid repetition, details are not described herein again.

As shown in FIG. 12, an embodiment of this application provides a media file play apparatus 1200. The media file play apparatus 1200 may include a sending module 1201, a receiving module 1202, and a play module 1203. The sending module 1201 is configured to send a first request message to a server, where the first request message is used to request to play a target media file, the target media file includes a first segment and a second segment, and a play sequence of the first segment is earlier than a play sequence of the second segment. The receiving module 1202 is configured to: after the sending module 1201 sends the first request message, receive a target configuration file sent by the server, where the target configuration file includes at least first index information and second index information, the first index information is used to indicate the first segment, and the second index information is used to indicate the second segment. The play module 1203 is configured to: after the receiving module 1202 obtains the first segment from the server based on the first index information, cache and play the first segment, and associate the first index information with the cached first segment; and the play module 1203 further retrieves cache content based on the second index information, and plays the cached first segment in a case that the second index information is the same as the first index information.

In this embodiment of this application, the play module 1203 may be further configured to: in a case that the second index information is different from the first index information, obtain the second segment from the server based on the second index information; and cache and play the second segment, and associate the second index information with the cached second segment.

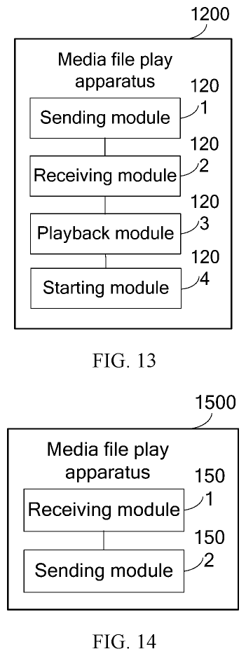

In this embodiment of this application, with reference to FIG. 12, as shown in FIG. 13, the media file play apparatus 1200 may further include a starting module 1204, configured to: in a case that there is one target media file, start a first player to play the first segment and the second segment based on the first index information and the second index information. In a case that there are two target media files, and the two target media files are respectively an audio file and a video file that are of one media file, the starting module 1204 is configured to: start a second player to play a first segment and a second segment in one target media file based on a target configuration file of the one target media file, and start a third player to play a first segment and a second segment in the other target media file based on a target configuration file of the other target media file.

The media file play apparatus provided in this embodiment of this application can implement the processes implemented by the electronic device in the foregoing method embodiment. To avoid repetition, details are not described herein again.

According to the media file play apparatus provided in this embodiment of this application, in a process in which the media file play apparatus downloads a segment of a target media file from a server, the media file play apparatus may first determine, based on second index information of a second segment, whether a local cache apparatus has a cached first segment that has same index information. If yes, it indicates that content of the second segment is the same as content of the first segment, the media file play apparatus directly reads the first segment from the cache apparatus, and plays the first segment without downloading the second segment from the server again. In this way, in a process of playing the target media file with duplicate segments, the media file play apparatus does not need to repeatedly download the duplicate segment, thereby saving traffic of downloading the duplicate segment.

The media file play apparatus provided in this embodiment of this application can implement the processes implemented by the electronic device in the foregoing method embodiment. To avoid repetition, details are not described herein again.

As shown in FIG. 14, an embodiment of this application provides a media file play apparatus 1500. The media file play apparatus 1500 may include a receiving module 1501 and a sending module 1502. The receiving module 1501 is configured to receive a first request message sent by an electronic device, where the first request message is used to request to play a target media file, the target media file includes a first segment and a second segment, and a play sequence of the first segment is earlier than a play sequence of the second segment. The sending module 1502 is configured to send a target configuration file to the electronic device based on the first request message received by the receiving module 1501, where the target configuration file includes first index information and second index information, the first index information is used to indicate the first segment, and the second index information is used to indicate the second segment, where the second index information is the same as the first index information in a case that the second segment and the first segment are duplicate segments.

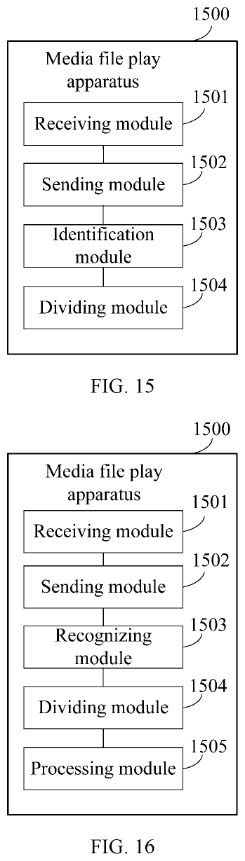

In this embodiment of this application, with reference to FIG. 14, as shown in FIG. 15, the media file play apparatus 1500 may further include an identification module 1503. The identification module 1503 is configured to identify the target media file before the sending module 1502 sends the target configuration file to the electronic device. The media file play apparatus 1500 may further include a dividing module 1504. The dividing module 1504 is configured to divide the target media file into a plurality of segments if there are duplicate segments in the target media file, where the plurality of segments include the first segment and the second segment.

In this embodiment of this application, the dividing module 1504 is configured to divide the target media file into the first segment and the second segment if duration of the duplicate segment in the target media file is greater than or equal to a preset threshold.

In this embodiment of this application, with reference to FIG. 14, as shown in FIG. 16, the media file play apparatus 1500 may further include a processing module 1505. In some embodiments, the processor 1505 is configured to: if there are synchronously duplicate segments in audio and a video in a media file, process the media file into one target media file; and if there are duplicate segments in audio or a video in a media file, process the media file into two target media files, where one of the two target media files is an audio file, and the other of the two target media files is a video file.

The media file play apparatus provided in this embodiment of this application can implement the processes implemented by the server in the foregoing method embodiment. To avoid repetition, details are not described herein again.

According to the media file play apparatus provided in this embodiment of this application, before an electronic device sends a first request message to the media file play apparatus, the media file play apparatus may first process and identify a target media file, and send a target configuration file to the electronic device, where the target configuration file includes a plurality of pieces of index information, and the plurality of pieces of index information include first index information and second index information. Therefore, the electronic device may receive the target configuration file based on the first request message, so that when downloading a segment based on index information, the electronic device does not need to download a duplicate segment, thereby saving traffic.

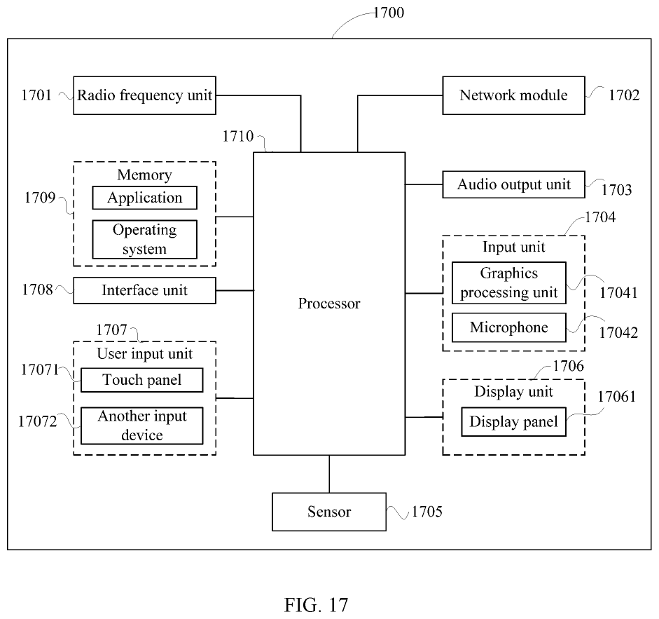

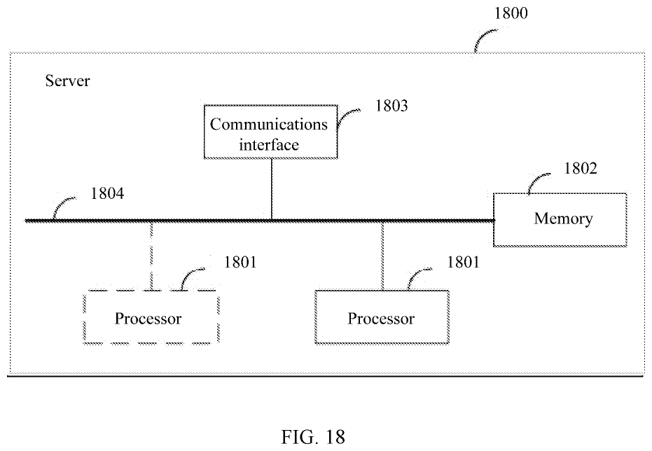

FIG. 17 is a schematic structural diagram of hardware of an electronic device according to the embodiments of this application. As shown in FIG. 17, an electronic device 1700 includes but is not limited to components such as a radio frequency unit 1701, a network unit 1702, an audio output unit 1703, an input unit 1704, a sensor 1705, a display unit 1706, a user input unit 1707, an interface unit 1708, a memory 1709, a processor 1710, and a power supply. A person skilled in the art may understand that a structure of the electronic device shown in FIG. 17 constitutes no limitation on the electronic device, and the electronic device may include more or fewer components than those shown in the figure, or have a combination of some components, or have a different component arrangement. In this embodiment of this application, the electronic device includes but is not limited to a mobile phone, a tablet computer, a notebook computer, a palmtop computer, an in-vehicle electronic device, a wearable device, a pedometer, and the like.

The radio frequency unit 1701 is configured to send a first request message to a server, where the first request message is used to request to play a target media file, the target media file includes a first segment and a second segment, and a play sequence of the first segment is earlier than a play sequence of the second segment; and the radio frequency unit 1701 is further configured to receive a target configuration file sent by the server, where the target configuration file includes at least first index information and second index information, the first index information is used to indicate the first segment, and the second index information is used to indicate the second segment.

In some embodiments, the memory 1709 is configured to: after the radio frequency unit 1701 receives the first segment sent by the server, cache the first segment in the memory 1708. The audio output unit 1703 and/or the display unit 1706 are/is configured to play the first segment.

In some embodiments, the processor 1710 is configured to: after the audio output unit 1703 and/or the display unit 1706 play/plays the first segment, associate the first index information with the cached first segment.

In some embodiments, the audio output unit 1703 and/or the display unit 1706 are/is further configured to: after caching the first segment in the memory, retrieve cache content based on the second index information, and play the cached first segment in a case that the second index information is the same as the first index information.

According to the electronic device provided in this embodiment of this application, after the electronic device 1700 sends, to a server, a first request message for playing a target media file, the server may send a target configuration file including a plurality of pieces of index information and that is corresponding to the target media file, so that the electronic device 1700 can play the target media file in segments. Therefore, when there are duplicate segments in the target media file, if duplicate segments have been cached in the electronic device 1700, the electronic device 1700 does not need to repeatedly download the duplicate segment from the server, thereby avoiding a waste of traffic when the electronic device 1700 plays a media file, and improving efficiency of playing the media file by the electronic device 1700.

In some embodiments, the radio frequency unit 1701 is further configured to: in a case that the second index information is different from the first index information, obtain the second segment from the server based on the second index information, and cache the second segment in the memory 1708. After the audio output unit 1703 and/or the display unit 1706 play/plays the second segment, the processor 1710 is further configured to associate the second index information with the second segment.

In some embodiments, the processor 1710 is further configured to: if there is one target media file, start one audio output unit 1703 and/or display unit 1706 to play the first segment and the second segment based on the first index information and the second index information. In a case that there are two target media files, the processor 1710 starts two frequency output units 1703 and/or display units 1706, where one frequency output unit 1703 and/or display unit 1706 play/plays a first segment and a second segment in one target media file based on the first index information and the second index information, and the other audio output unit 1703 and/or display unit 1706 play/plays a first segment and a second segment in the other target media file based on the first index information and the second index information.

It should be understood that, in this embodiment of this application, the radio frequency unit 1701 may be configured to receive and send information or a signal in a call process. In some embodiments, after receiving downlink data from a base station, the radio frequency unit 1701 sends the downlink data to the processor 1710 for processing. In addition, the radio frequency unit 1701 sends uplink data to the base station. Usually, the radio frequency unit 1701 includes but is not limited to an antenna, at least one amplifier, a transceiver, a coupler, a low noise amplifier, a duplexer, and the like. In addition, the radio frequency unit 1701 may communicate with a network and another device through a wireless communication system.

The electronic device provides wireless broadband Internet access for the user by using the network unit 1702, for example, helping the user to send and receive an e-mail, brows a web page, and access streaming media.

The audio output unit 1703 may convert audio data received by the radio frequency unit 1701 or the network unit 1702 or stored in the memory 1709 into an audio signal and output the audio signal as a sound. In addition, the audio output unit 1703 may further provide an audio output (for example, a call signal received voice, or a message received voice) related to a specific function implemented by the electronic device 1700. The audio output unit 1703 includes a speaker, a buzzer, a telephone receiver, and the like.

The memory 1709 may be configured to store a software program and various data. The memory 1709 may mainly include a program storage area and a data storage area. The program storage area may store an operating system, an application program required by at least one function (such as a sound play function or an image play function), and the like. The data storage area may store data (such as audio data or an address book) created based on use of the mobile phone, and the like. In addition, the memory 1709 may include a high-speed random access memory, and may further include a nonvolatile memory, for example, at least one magnetic disk storage device, a flash storage device, or another volatile solid-state storage device.

The processor 1710 is a control center of the electronic device, connects all parts of the entire electronic device by using various interfaces and lines, and performs various functions of the electronic device and data processing by running or executing a software program and/or a module that are/is stored in the memory 1709 and by invoking data stored in the memory 1709, to overall monitor the electronic device. The processor 1710 may include one or more processing units. In some embodiments, an application processor and a modem processor may be integrated into the processor 1710. This application processor mainly processes an operating system, a user interface, an application program, and the like. The modem processor mainly processes wireless communication. It can be understood that the modem processor may not be integrated into the processor 1710.

In addition, the electronic device 1700 includes some function modules not shown, and details are not described herein.

An embodiment of this application further provides an electronic device, including the processor 1710, the memory 1709, and the computer program that is stored in the memory 1709 and that can be run on the processor 1710 that are shown in FIG. 17, and the computer program is executed by the processor 1710 to implement the processes of the foregoing method embodiment and a same technical effect can be achieved. To avoid repetition, details are not described herein again.

FIG. 18 is a schematic structural diagram of hardware of a server according to an embodiment of this application. As shown in FIG. 18, a server 1800 may include one or more processors 1801, a memory 1802, a communication interface 1803, and a bus 1804.

The processor 1801 may be configured to: receive, by using the bus 1804 and the communication interface 1803, a first request message sent by an electronic device, where the first request message is used to request to play a target media file, the target media file includes a first segment and a second segment, and a play sequence of the first segment is earlier than a play sequence of the second segment; and send a target configuration file to the electronic device by using the bus 1804 and the communication interface 1803, where the target configuration file includes first index information and second index information, the first index information is used to indicate the first segment, and the second index information is used to indicate the second segment, where the second index information is the same as the first index information in a case that the second segment and the first segment are duplicate segments.

According to the server provided in this embodiment of this application, the server 1800 may perform slice processing on a target media file to divide the target media file into a plurality of segments, and configure corresponding index information, and when playing a duplicate segment based on the index information, an electronic device does not need to repeatedly download these duplicate segment from the server, so that the electronic device can save traffic when playing the target media file.

In some embodiments, the processor 1801 may further identify the target media file; and divide the target media file into a plurality of segments if there are duplicate segments in the target media file, where the plurality of segments include the first segment and the second segment.

In some embodiments, the processor 1801 may further divide the target media file into a plurality of segments if duration of the duplicate segment in the target media file is greater than or equal to a preset threshold.

In some embodiments, the processor 1801 is configured to: if there are synchronously duplicate segments in audio and a video in a media file, process the media file into one target media file; and if there are duplicate segments in audio or a video in a media file, process the media file into two target media files, where one of the two target media files is an audio file, and the other of the two target media files is a video file.

In this embodiment of this application, the one or more processors 1801, the memory 1802, and the communication interface 1803 are connected to each other by using the bus 1804. The bus 1804 may be a Peripheral Component Interconnect (PCI) bus, an Extended Industry Standard Architecture (EISA) bus, or the like. The bus 1804 may be classified into an address bus, a data bus, a control bus, and the like. For ease of indication, the bus is indicated by using only one bold line in FIG. 18. However, it does not indicate that there is only one bus or only one type of bus. In addition, the server 1800 may further include some function modules not shown, and details are not described herein.

An embodiment of this application further provides a server, including the processor 1801, the memory 1802, and the computer program that is stored in the memory 1802 and that can be run on the processor 1801 that are shown in FIG. 18, and the computer program is executed by the processor 1801 to implement the processes of the foregoing method embodiment and a same technical effect can be achieved. To avoid repetition, details are not described herein again.

An embodiment of this application further provides a computer-readable storage medium. The computer-readable storage medium stores a computer program, and the computer program is executed by the radio frequency unit 1701, the memory 1709, and the processor 1710 shown in FIG. 17, or the processor 1801 shown in FIG. 18 to implement the processes of the foregoing method embodiment and a same technical effect can be achieved. To avoid repetition, details are not described herein again. The computer-readable storage medium includes a Read-Only Memory (ROM), a Random Access Memory (RAM), a magnetic disk, or an optical disc.

An embodiment of this application further provides a chip. The chip includes a processor and a communication interface, the communication interface is coupled to the processor, and the processor is configured to run a program or an instruction to implement the processes of the foregoing media file play method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

It should be noted that, in this specification, the terms “include”, “comprise”, or their any other variant is intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element limited by “includes a . . . ” does not, without more constraints, preclude the presence of additional identical elements in the process, method, article, or apparatus that includes the element.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (such as a ROM/RAM, a hard disk, or an optical disc), and includes several instructions for instructing an electronic device (which may be mobile phone, a computer, a server, a network device, or the like) to perform the methods described in the embodiments of this application.

The embodiments of this application are described above with reference to the accompanying drawings, but this application is not limited to the above specific implementations, and the above specific implementations are only illustrative and not restrictive. Under the enlightenment of this application, those of ordinary skill in the art can make many forms without departing from the purpose of this application and the protection scope of the claims, all of which fall within the protection of this application.

1. A media file play method, comprising:
sending a first request message to a server, wherein the first request message is used to request to play a target media file, the target media file comprises a first segment and a second segment, and a play sequence of the first segment is earlier than a play sequence of the second segment;
receiving a target configuration file sent by the server, wherein the target configuration file comprises at least first index information and second index information, the first index information is used to indicate the first segment, and the second index information is used to indicate the second segment;
after the first segment is obtained from the server based on the first index information, caching and playing the first segment, and associating the first index information with the cached first segment; and
retrieving cache content based on the second index information, and playing the cached first segment when the second index information is the same as the first index information.

2. The media file play method according to claim 1, wherein after retrieving the cache content based on the second index information, the method further comprises:
when the second index information is different from the first index information, obtaining the second segment from the server based on the second index information; and
caching and playing the second segment, and associating the second index information with the cached second segment.

3. The media file play method according to claim 1, further comprising:
when there is one target media file, starting a first player to play the first segment and the second segment based on the first index information and the second index information.

4. The media file play method according to claim 1, further comprising:
when there are two target media files, and the two target media files are respectively an audio file and a video file that are of one media file, starting a second player to play a first segment and a second segment in one target media file based on a target configuration file of the one target media file, and starting a third player to play a first segment and a second segment in the other target media file based on a target configuration file of the other target media file.

5. An electronic device, comprising: a memory storing a computer program; and a processor coupled to the memory and configured to execute the computer program to perform operations comprising:
sending a first request message to a server, wherein the first request message is used to request to play a target media file, the target media file comprises a first segment and a second segment, and a play sequence of the first segment is earlier than a play sequence of the second segment;
receiving a target configuration file sent by the server, wherein the target configuration file comprises at least first index information and second index information, the first index information is used to indicate the first segment, and the second index information is used to indicate the second segment;
after the first segment is obtained from the server based on the first index information, caching and playing the first segment, and associating the first index information with the cached first segment; and
retrieving cache content based on the second index information, and playing the cached first segment when the second index information is the same as the first index information.

6. The electronic device according to claim 5, wherein after retrieving the cache content based on the second index information, the operations further comprise:
when the second index information is different from the first index information, obtaining the second segment from the server based on the second index information; and
caching and playing the second segment, and associating the second index information with the cached second segment.

7. The electronic device according to claim 5, wherein the operations further comprise:
when there is one target media file, starting a first player to play the first segment and the second segment based on the first index information and the second index information.

8. The electronic device according to claim 5, wherein the operations further comprise:
when there are two target media files, and the two target media files are respectively an audio file and a video file that are of one media file, starting a second player to play a first segment and a second segment in one target media file based on a target configuration file of the one target media file, and starting a third player to play a first segment and a second segment in the other target media file based on a target configuration file of the other target media file.

9. A non-transitory computer-readable storage medium, storing a computer program, when the computer program is executed by a processor of an electronic device, causes the processor to perform operations comprising:
sending a first request message to a server, wherein the first request message is used to request to play a target media file, the target media file comprises a first segment and a second segment, and a play sequence of the first segment is earlier than a play sequence of the second segment;
receiving a target configuration file sent by the server, wherein the target configuration file comprises at least first index information and second index information, the first index information is used to indicate the first segment, and the second index information is used to indicate the second segment;
after the first segment is obtained from the server based on the first index information, caching and playing the first segment, and associating the first index information with the cached first segment; and
retrieving cache content based on the second index information, and playing the cached first segment when the second index information is the same as the first index information.

10. The non-transitory computer-readable storage medium according to claim 9, wherein after retrieving the cache content based on the second index information, the operations further comprise:
when the second index information is different from the first index information, obtaining the second segment from the server based on the second index information; and
caching and playing the second segment, and associating the second index information with the cached second segment.

11. The non-transitory computer-readable storage medium according to claim 9, wherein the operations further comprise:
when there is one target media file, starting a first player to play the first segment and the second segment based on the first index information and the second index information.

12. The non-transitory computer-readable storage medium according to claim 9, wherein the operations further comprise:
when there are two target media files, and the two target media files are respectively an audio file and a video file that are of one media file, starting a second player to play a first segment and a second segment in one target media file based on a target configuration file of the one target media file, and starting a third player to play a first segment and a second segment in the other target media file based on a target configuration file of the other target media file.

13. A computer program product, wherein the computer program product is executable by at least one processor to implement the media file play method according to claim 1.

14. A chip, comprising a processor and a communication interface, wherein the communication interface is coupled to the processor, and the processor is configured to run a program or an instruction to implement the media file play method according to claim 1.
